(19) United States
(12) Patent Application Publication
(10) Pub. No.: US 2002/0153251 A1
(43) Pub. Date: Oct. 24, 2002

(54) Multichannel control in microfluidics

(76) Inventors: Alexander Sassi, Berkeley, CA (US); Aran Paulus, San Diego, CA (US)

Correspondence Address: LAW OFFICE OF THOMAS SCHNECK, P.O. BOX 2-E, SAN JOSE, CA, 95109-0005, US

(21) Appl. No.: 10/121,378

(22) Filed: Apr. 11, 2002

Related U.S. Application Data
(63) Continuation of application No. 09/497,303, filed on Feb. 2, 2000.
(60) Provisional application No. 60/118,344, filed on Feb. 3, 1999.

(51) Int. Cl. G01N 27/26; G01N 27/447

(52) U.S. Cl. 204/455; 204/451; 204/450; 204/600; 204/601; 204/605; 422/99; 435/288.4; 435/288.5

(57) ABSTRACT

Microfluidic devices are provided where barriers are introduced between different compartments of the device to prevent fluid flow between the two compartments. Different materials and methods are employed for the introduction and removal of the barriers, including reversible gel particle expansion, reversible gellation, in situ polymerization, magnetic beads, and the like. In this way mixing of agents may be temporally controlled during the operation of the device, where the barriers may be used in a passive manner or as an active agent involved in the operation being performed in the device.

### CROSS-REFERENCE TO RELATED APPLICATION

This is a continuation of Ser. No. 09/497,303 filed Feb. 2, 2000, which claims priority from Ser. No. 60/118,344 filed Feb. 3, 1999.

### TECHNICAL FIELD

The field of this invention is microfluidics, using an electrical field to move particles through capillaries.

### BACKGROUND OF THE INVENTION

The use of electrical fields to separate particles in complex mixtures into their component parts is well established. Gel electrophoresis, isotachophoresis and isoelectric focusing find expanding use as the demands of biology and medicine increase and our abilities to isolate and create new chemical entities expands. The use of electrical fields is also employed for the movement of small volumes in capillaries, where components of a medium may be moved within or between channels in a capillary device. Microfluidics allows for the manipulation of small volumes in a variety of separation, concentration and purification systems, which are commonly performed on a macro scale. However, as interest has increased in using increasingly smaller amounts of material, due to the small amount of sample available, the interest in accelerating the time required for a reaction to occur, the need to perform a large number of different operations on a single sample or multiple samples, and the like has led to the development of microfluidics.

Microfluidics employs capillaries as the channel in which various activities occur, where electrical Fields or pressure differentials are created in the channels to move mixture components from site to site. These new miniature systems have expanded on the electrophoretic capabilities in providing chemical laboratories on a chip, where one may have a plurality of intersecting channels, reagent chambers and the ability to change the environment at individual sites or for the entire device. The present miniature devices are not limited to separation, but allow for chemical reaction, affinity binding, diagnostic assays, identification of entities, manipulation of very small volumes for any purpose, and other operations.

Devices having multiple intersecting channels are described in U.S. Pat. No. 5,858,188. In these devices various compositions may be introduced into a specific channel, e.g. a main channel or branched channel, where one wishes to perform independent operations. Thus, one may wish to isolate particular regions of what may be called the movement area, which is the area in which movement of sample, reagents and media occurs. In one example, one may wish to introduce a particular medium in the main channel without the medium entering a branched channel. One may wish to put into chambers various reactants, which should not mix with other materials present in other channels. In some instances, one may wish to have a reaction proceed, followed by the addition of a reagent, where the device is originally charged with the reagent and at the appropriate time the reagent is introduced into the reaction chamber. With the use of particles, one may wish to impede the movement of particles at various times or isolate the particles to a particular compartment in the movement area.

### SUMMARY OF THE INVENTION

Methods for formation of a barrier between channels in a microfluidic device, and utilization of these barriers for conducting reactions are provided. A first embodiment of the present invention discloses a method to create a barrier to flow in a microfluidic device, comprising the steps of introducing a photopolymerizable material in an intersection between two microchannels in the device, and forming a localized gel by photopolymerization at the intersection. The localized gel acts to create a barrier to the flow of materials in the intersection. This method may be applied to a microfluidic network formed from a plurality of intersecting microchannels. Such a microfluidic network may be formed from enclosed channels patterned into a substrate. In an alternative embodiment, the gel may be locally formed within a length of one microchannel bounded by two openings. One method for localized formation of the gel includes using a mask to shield from light portions of the microchannels in which polymerization is not desired.

In certain embodiments, the photopolymerization mixture includes a monomer and a photoactivated initiator. In some embodiments, a light emitting diode may effect photopolymerization. In other embodiments, photopolymerization may be effected by ultraviolet light.

The method may further include removal of nonpolymerized liquid from the intersecting microchannels. Including a first and second opening into the microchannel in which polymerization is to take place allows for removal of nonpolymerized material. After polymerization, fluid is evacuated through the first opening, and replacement fluid is introduced through the second opening.

The methods of the invention may comprise reversible formation of a localized gel. In these embodiments, the methods may further comprise the step of removing the localized gel.

Another embodiment of the invention includes a device comprising two intersecting microchannels, with a localized, photopolymerized gel filling the volume formed by intersection of the microchannels. The intersecting channels may be disposed at right angles to each other. One or more of the microchannels may further comprise a pair of ports, both disposed on one side of the gel contained in the intersection.

The methods of the invention further enable means for effecting reactions in a microfluidic network, wherein the network comprises two microchannels intersecting at an angle. This embodiment comprises the steps of filling the first and second microchannels with a photopolymerizable mixture, illuminating an area of the intersection to cause localized gel photopolymerization at the intersection, removing the unpolymerized mixture from the microchannels, introducing a reaction mixture into the first microchannel, effecting a reaction in the first microchannel, and moving products of the reaction by electrophoresis through the gel contained in the intersection and into the second microchannel. The methods of the invention may be beneficially employed for several types of reactions, including thermally-cycled reactions such as the polymerase chain reaction or nucleic acid sequencing reactions, as well as isothermal reactions, including compound screening reactions.

### BRIEF DESCRIPTION OF THE DRAWINGS

FIG. 1 provides a diagrammatic view of a microfluidic device for use according to the subject invention.

FIGS. 2A-D are diagrammatic views of an embodiment of a process for creating a wall in a microfluidic device.

FIGS. 3A-D are diagrammatic views of an alternative embodiment for creating a barrier between two channels in a microfluidic device.

FIGS. 4A-D illustrate the use of superparamagnetic beads in the present invention.

FIG. 5 illustrates a channel design for use according to the subject invention.

### DESCRIPTION OF THE SPECIFIC EMBODIMENTS

Microfluidic devices are provided where barriers to flow are introduced at intersections between functional areas of the device, which barriers are porous and allow for movement of chemical entities under the influence of an electrical field, or alternatively may provide for retention of particles. The barriers may take a variety of forms: formed of a polymeric composition, which may be preformed or formed in situ, magnetic beads, etc. The microfluidic devices have a plurality of functional areas comprising at least one capillary channel or trough and may have reagent chambers, where the cross-sectional dimensions of the chamber will be greater than the cross-sectional dimensions of the channel, which area may be referred to as the “movement area.”

The microfluidic devices arc used to manipulate particles, which may be charged or uncharged, and include individual entities, such as ions and molecules, as well as aggregates of entities, such as complexes involving two or more molecules, large aggregates, such as organelles, cells, viruses, or other entities, usually less than about 1 μ.

The microfluidic devices will usually be small solid substrates, which may be referred to as chips. The substrate may be any convenient material, including plastics, e.g. acrylics, glass, silicon, ceramic, or other convenient material, which may be fabricated. The devices may be long sheets or slabs comprising numerous fluidic systems. However, generally, the largest dimension will be less than about 100 cm, usually less than about 50 cm and not less than about 1 cm. Depending on the particular function of the device, the device may range from about 10 to 20 cm or longer, for example for DNA sequencing, or from about 2 to 10 cm, for other applications, such as drug screening. The thickness of the device may be varied and may involve a number of different layers, particularly where temperature control is provided. Generally the device will be at least about 10 μm high or thick and not more than about 50 mm, usually not more than about 20 mm.

The channels will usually have cross-sections in the range of about 25 to 2000 μm², more usually in the range of about 100 to 500 μm², although in some instances the channels may be larger or smaller by an order of 10. Channels may be of varying length, usually be at least about 5 μm and may run substantially the length of the device, usually being less than about 100 cm, more usually being less than about 50 cm, frequently less than about 15 cm, where the channel maybe interrupted by one or more chambers. Again, the length of the channel will generally be determined by the function for which the device is being used. The channel may be straight, angled, tortuous, or any path, depending on the nature of the device and its use.

Generally, a cover will be used to enclose the channels and chambers, which cover may be a film, plate, or the like, and may provide ports for introduction and removal of fluids, provide for electrodes to contact the media in the channels and chambers, may also serve to control the environment as specific sites, e.g. temperature, provide access to light for introducing radiation and/or observing radiation, and the like. Alternatively, the substrate may provide one or more of these features. In some instances ports and electrodes may be along the edges of the device.

The device may have a single microfluidic system or a plurality of microfluidic systems, which may be run concurrently or independently. The number of fluidic systems will be at least one and not more than about 5,000, usually not more than about 1,000. The device will usually include one or more source and/or waste wells, which may provide tile fluid for the channel, particularly for separations, and accommodate the waste from one or more systems or a single system may have a plurality of source and waste wells, generally from about 1 to 10, usually from about 1 to 5 of each. Alternatively, wells may be external to the device and feed and receive fluids through conduits connected to the ports.

The electrodes can be formed photolithographically to be in contact with the media at specific positions in the channels and, when appropriate, in the chambers and wells. Alternatively, the electrodes may be individually positioned exterior to the device and extend into a capillary or chamber through a port or a combination of the two methods may be employed. The device will usually be used with an automated instrument, which may provide the electrodes or contacts to the electrodes. By having electrodes at various sites in the system, entities may be moved from position to position to perform the diverse operations which are feasible with the subject devices.

The barriers may be of any length above a minimum of about 0.05 μm. Usually the barriers which will be employed will generally be at least about 0.1 mm, more usually at least about 0.2 mm, and may be much larger, usually not exceeding the length of a channel, usually not more than about 1 cm, more usually not exceeding 0.5 cm, and preferably not exceeding 0.25 cm, depending on the nature of the composition of the barrier, the function of the barrier, the manner of formation, and the like.

In utilizing the devices for introduction of barriers, one or more capillaries or chambers may be filled with the agent for producing the barriers. In one embodiment, the composition will be a free-flowing composition comprised of a material, which may have one or more components, which will produce a physical barrier to fluid flow. The composition may have a monomer, which by itself or in combination with other components, will polymerize, particularly under photoinitiation, or a composition which will gel or solidify by a change in conditions, e.g. temperature, pH, solvent, ionic strength, etc. Various monomers may be employed, including monomers which find use in gel electrophoresis, such as acryl (including methacryl) monomers, particularly acrylamides, where the nitrogen may be substituted, thermo-reversible polymers, where heating or cooling results in a change in their physical properties, such as acrylic polymers, e.g. hydroxyalkylacrylamides and—methacrylamides, hydroxyalkylacrylates and—methacrylates, silicones, sulfonated styrenes, urethane oligomers, polysaccharides, e.g. agarose and hydroxyalkylcellulose, etc. See particularly, U.S. Pat. Nos. 5,569,364 and 5,672,297. Polymeric particles may be employed where a change in the medium results in the swelling or shrinking of the particles.

Of particular interest are acrylamides that are polymerized with a photoinitiator. The composition may include a cross-linker, which is stable or labile, particularly labile, more particularly photolytically labile at a shorter wavelength than the wavelength used for photoinitiation. Alternatively, the cross-linker may be thermally or chemically labile, or the polymer may be soluble in a solvent that can be accommodated by the system. Functional groups that may be employed include azo, disulfide, peroxide, α-diketo, etc. Thus, non-cross-linked and cross-linked polymers are envisioned. After introducing the barrier—forming composition into the appropriate areas of the system, the barriers may then be formed at the desired sites. By using masks, formation of the barrier will be restricted to the area being irradiated. Useful means for masking, which are known in the art, include photolithographic masks, ink designs on the surface of the device, focused light or other means for limiting the radiation to the site of interest. For example, if one wishes to protect side channels from leakage of the medium in a main channel, formation of the barrier is performed at the sites of intersection of the main channel. By controlling the pressure and/or volume of the fluid in the two different channels, control of the site of the barrier may be achieved. Further control, may be achieved with an electrostatic field, where the fluids differ as to their composition and ionic strength. Thus, one may control the path of the composition, by the site at which the composition is introduced and controlling the volume of the composition, using an electrical field by including charged entities in the fluid, occupying a channel with a composition, so that the barrier-forming composition is inhibited from entering the channel, and the like. Alternatively, one may have monomer in one channel and initiator in another channel that intersects with the first channel. The monomer and initiator will diffuse together at the intersection. By irradiating or heating at the intersection, or merely bringing the two media together, depending on the nature of the initiator, a barrier will be created at the intersection.

Various monomers to be used to form polymers or various preformed polymers may be employed, where metal atoms or ions are employed, such as Ag, Fe, Cu, Ni, Mg, Cr, etc., which are readily chelated and provide for the passage of electrical current in the polymer. These polymeric barriers may have the metal present when introduced into the channel or the metal may be added to the polymer later, by introducing the metal into the channel where it is transported to the barrier and captured by the barrier. Various functionalities may be employed for capturing the metal, such as di- or higher order imidazoles, carboxy groups, amino groups, mercapto groups, sulfinic acids, oximino, etc. individually or in combination. Metals may be present initially, using metallocenes, chelates, and the like. When the barrier is to be removed, an electric current may be applied to the barrier that will destroy the barrier, leaving the channel free.

It may be desirable to include a viscous solution in channels or reservoirs adjacent to the area where the barrier is to be introduced. This serves to minimize hydrodynamic flow in the channels during polymerization. Various inert thickening agents may be used, such as hydroxyethylcellulose, agarose, poly(vinyl alcohol), poly(vinyl alcohol/acetate), sucrose, etc.

Where one controls the path of the composition by the volume, one introduces the barrier-forming composition at an appropriate port and allows the composition to move to the intersection at which a barrier is to be formed. Depending on the nature of the composition, the barrier is then created at the intersection by using a local agent that induces gellation or solidification. For example, particles may be used, which expand and contract with a change in a variety of conditions. The particles will generally be small enough to readily flow in the channel, varying in dry size from about 0.1 to 50 μm, where the matrix for the magnetic material can fuse to form a continuous barrier. If one wished to form a barrier between a side channel and a main channel, the particles would be put into the side channel in a fluid stream and extend to about the intersection. The main channel would then be filled with a medium that would make the particles swell. The medium behind the swollen particles would then be removed in any convenient manner. By having a port at about the barrier site, which may be sealable, the fluid in the side channel may be withdrawn using an absorbent paper or cloth. One may then fill the side channel with the medium that maintains the particles in a swollen condition. To provide improved blockage, one may constrict the side channel at the intersection with the main channel, so as further enhance the barrier. The fluid from the main channel is withdrawn and replaced with a different medium, which is now blocked from entering the side channel.

Barriers may be created by tilling the capillaries with a buffer and pumping a solution of a gel-forming agent into the main capillary while maintaining the temperature of the device above the gel transition temperature. Intrusion of the gel-forming agent into a side capillary can be controlled by pressure applied through electroosmotic or other forces. The device is then cooled causing a gel to form in the main capillary and in a predetermined length of a side capillary. Application of sufficient electrical potential along the length of the main capillary will cause localized heating and melting of the gel leaving the gel only in the side capillary. The main capillary can then be flushed free of the gel forming agent. As desired, the gel barrier may be removed from the side capillary by heating the gel using thermal or electrostatic heating and then removed. Compositions such as agarose, by itself or in combination with other polymeric compositions may be employed to modify the nature of the barrier.

With an electrical field, one can move the medium through the various component domains of the system. At each intersection at which a barrier is to be installed, the composition would be treated to form the barrier. For example, with photoinitiated polymerization, one would fill the capillaries with a polymerizable medium and irradiate the medium at the intersection to form the barrier, using masks or other means to localize the irradiation to the position where the barrier is to be placed. The polymerizable medium may then be removed by any convenient means, such as electroosmosis, washing out the polymerizable medium with a wash medium, highenergy irradiation, chemical treatment or using an absorbent medium at a port which would withdraw the polymerizable medium, or it combination of these and other methods. Alternatively, one may have a side channel into which one may draw the composition electroosmotically.

The polymerizable medium will require a monomer and may also require an initiator. Depending on the monomer, various conventional polymerization initiation systems may be employed, such as APS (ammonium persulfate) and TEMED (tetramethylene diamine), methylene blue and toluidine sulfate, riboflavin and TEMED, methylene blue, methylene blue and TEMED, methylene blue/sodium toluene sulfate/DPIC (diphenyl iodonium chloride), riboflavin 5′-phosphate, riboflavin 5′-phosphate/TEMED/DPIC, hydrogen peroxide/potassium persulfate, 1-[4-(2′-hydroxyethoxy)phenyl]-2-hydroxy-2-methyl-1-propane-1-one, 1-hydroxycyclohexyl phenyl ketone, 2-hydroxy-2-methyl-1-phenylpropan-1-one, etc.

Alternatively, one may fill the main and other channels and chambers with a medium and then force the barrier-forming medium to an intersection using pressure and/or vacuum at the entry port of the barrier-forming medium or an another, directing the other medium out of the channel, until the barrier-forming medium has reached the intersection. At this time one forms the barrier and then removes the two media from the device.

Depending on the nature of the barrier medium, the barrier may be abolished, while leaving the barrier composition in the device, the barrier composition may be removed through a port or channel or other convenient means, depending on the configuration of the device, the nature of the composition and the other agents present in the device. In some instances, the barrier composition may be part of the medium used in the channel. In other instance it may be dissolved in a solvent and the solvent withdrawn, the medium may be melted by an elevated temperature, a change in pH or ionic strength may serve to contract the barrier, and the like. Once the barrier had been abolished, one may proceed with the operations of the device involving the segregated channel or chamber.

The subject devices find a variety of uses in being able to separate components of a mixture by charge and/or size, perform chemical reactions, diagnostic assays, nucleic acid and protein sequencing, identification of cell species, receptors and the like, using intact or fragmented cells or cell walls or membranes, inhibit the passage of particles, serve as a source for a reagent allowing for reactions on or at the barrier, do biologically active compound screening, particularly drug screening using particular targets and candidate drugs or other biologically active compounds, etc. There is an extensive literature on the manner in which capillaries may be used in combination with an electrical field for moving entities from one site to another, where the different operations may be performed.

The barrier may serve as a source of a reagent, where the monomer may carry the reagent, the reagent may react with the barrier so as to be covalently bonded to the barrier, the gel may be reacted with the reagent prior to its introduction at the barrier site, or particles carrying the reagent may be blocked from flowing past the barrier, so that the reagent is on the particles at the barrier site. In this way the barrier may serve not only as a passive restraint, but also as an active participant in the operation being carried out by the device. Of particular interest is the use of specific binding pair (“SBP”) members, where one member of the SBP is bonded to the barrier. Examples of SBP members are ligands and receptors (which includes antibodies, both naturally occurring and synthetic, and cell surface receptors), enzymes and their substrates and inhibitors, sugars and lectins, cyclic hosts (e.g. paracyclophanes, cyclodextrins, etc.) and ligand guests, homologous nucleic acid sequences, chelating compounds and metalloorganics, etc. Of particular interest are ligands and receptors, such as biotin and avidin or streptavidin, antibodies and their ligands, exemplified by digoxin and antidigoxin, fluorescein and antifluorescein, green fluorescent protein and anti(green fluorescent protein), etc.

The barrier may serve to concentrate a component of a sample. For example, particles comprising oligonucleotides may be combined with a denatured DNA sample or an RNA sample, under stringent hybridization conditions. Only those sequences in the sample that have a sequence at least substantially homologous to the oligonucleotide will become bound to the particles. The sample medium may then be moved electrostatically through a barrier-containing channel, where the particles will be concentrated at the barrier and the residual DNA flow through the barrier. The conditions at the barrier may then be changed to release the captured DNA. The conditions may be such as to also remove the barrier, e.g. heat, which melts the barrier and the DNA releasing the captured DNA. The captured DNA may then be moved to a sequencing gel in a capillary, used for transcription in a cellular lysate containing the necessary factors for transcription, expanded by PCR, copied to provide double stranded DNA and inserted into a plasmid, or many other possible operations.

Instead of using the deterred particles as a source of a reagent, one may use the polymer. Agarose may be linked or covalently bonded with a SBP or an acryl monomer may have an SBP. For example, biotin may be linked to the agarose or linked to the acryl group through the carboxy group. The barrier would then have biotin available for binding to its receptor, avidin or streptavidin. The reverse could also be true where the avidin is bound to the barrier and will bind to biotin in the medium. One could then use the barrier to capture various agents to which biotin or avidin has been bound. Antibodies to a compound(s) of interest could be conjugated to avidin and the conjugate added to a sample. The compounds) of interest could be an enzyme, a receptor, or a small organic molecule drug. The antibodies would bind to any compounds) of interest in the sample and then be directed electrokinetically down the channel to the conjugated barrier, where the antibody and its ligand would be captured. The enzyme could then be assayed, released by changing the ionic strength and/or temperature at the site of the barrier, or the like. The fluid at the barrier could then be moved as a slug, where the enzyme would be highly concentrated in a very small volume. The released enzyme could then be assayed, used in a reaction, where the enzyme could be used to screen drugs as antagonists or substrates, or combined with other enzymes to perform a series of enzymatic reactions.

The barrier could also be used in performing immunoassays. For example, one could bind avidin to the barrier. At a port to the channel in which the barrier has been introduced, if one is measuring an antigen, one would add the sample and antibody conjugated to biotin and antibody conjugated to a fluorescent molecule or enzyme, where the antibodies bind to the antigen at different epitopic sites. The sample medium is then transferred electrokinetically to the barrier where the components of the sample medium flow through the barrier. The antibodies conjugated to biotin will be captured, but the antibodies conjugated to the fluorescent molecule will only be captured to the extent that antigen is present, by the antigen acting as a bridge or sandwich between the two differently conjugated antibodies. For the fluorescent label, one would irradiate the barrier with excitation light and read the level of fluorescence. For the enzyme, one would electrokinetically move a substrate to the barrier, where the product of the enzymatic reaction is chemiluminescent or fluorescent. Because one can make the area of the barrier very small, one concentrates the signal in a small area, providing for high sensitivity.

One may also use the barrier as a catalyst to perform a catalytic reaction in a small volume. For example, one may use a redox catalyst bonded to the barrier composition. If one has a reagent which is oxidatively labile when in the reduced form, one can pass a slug of the oxidized form through the barrier, where it will be reduced and then move the reduced reagent to a reaction chamber in conjunction with other reagents for performing a reaction on the reduced form of the reagent.

One may use the barrier to define a site in the fluidic device. By introducing fluorescent particles into the device, the particles will travel through the device until they encounter the barrier. Depending on the number of particles introduced, one may have a very fine line of fluorescence or a thick line or something in between.

The above illustrations are only a few of the operations possible by use of barriers. The barriers provide extraordinary flexibility in their use, serving a passive mechanical role of impeding the movement of particles, including cells, organelles, and other aggregations of molecules, and polymeric particles, and molecules or may serve as an active role in being one component of a chemical operation.

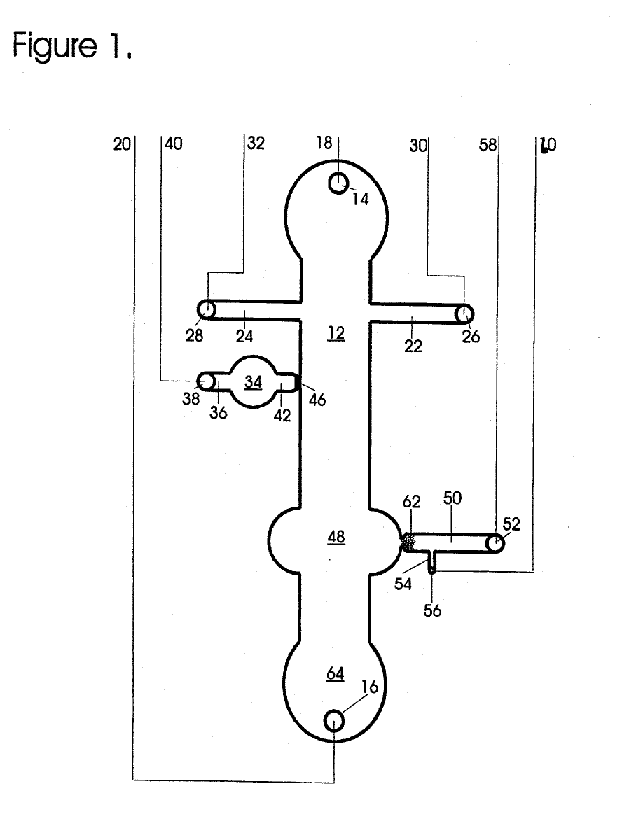

For further understanding of the invention, the drawings will now be considered. The microfluidics device 10 depicted in FIG. 1 is a plan view. The device, which has been previously described in the literature, as indicated above, has a base plate with a number of features to be described and a cover plate, where the features have communication to the atmosphere and to electrodes. The channels are of capillary dimensions, where the wells and chambers may have from 2 to 20 times the dimensions of the capillaries. The device has a main channel 12, with a first port 14 and a second port 16, into which electrodes 18 and 20 intrude to provide an electrical field across the main channel as well as with the other electrodes for controlled movement of particles (includes molecules, small particles, aggregations of molecules, such as cells, organelles, etc.) through the channels of the device. In the main channel is a medium, which may be an electrophoretic medium, buffer or polymeric solution, which find use for transporting particles by electroosmostic flow or electrophoretically, providing electrophoretic separation, or other operation, as appropriate. The same or other media may be in the other channels.

As device 10 is depicted, it has two side upper channels, 22 and 24 which face each other and provide a pathway intersecting with the main channel 10. The side channels 22 and 24 are referred to as upper to the extent that the flow of fluid in the main channel 12 flows in the direction from port 14 to port 16. Upper side channels 22 and 24 have ports 26 and 28 for receiving electrodes 30 and 32, respectively, and components for performing the operations associated with the use of the device 10. The upper side channels 22 and 24 are open to the main channel 12, so that fluid may move between the channels. Along main channel 12 in the direction of flow is side chamber 34, having an inlet conduit 36 with port 38 and electrode 40, and a constricted outlet conduit 42. At the intersection between the outlet conduit 42 and the main channel is a polymeric barrier wall 46. The polymeric barrier wall is comprised of a polymer, which will allow for the flow of liquid when under an electrical field, but will inhibit mechanical flow, when only under the influence of mild mechanical forces. The main channel 12 comprises a reaction chamber that communicates with lower channel 50. Lower channel 50 has port 52 and is connected with side channel 54, which has port 56. Electrodes 58 and 60 intrude into ports 52 and 56, respectively, to provide an electrical field with each other and the other electrodes when activated. Channel 50 is constricted and the constriction is blocked by a wall 62 of expanded gel particles. The gel particles may be melted and are of an innocuous composition that does not interfere with the assay mixture. Main channel 12 terminates in waste well 64, which has port 16 into which electrode 20 extends to provide the main electrical field along the main channel.

An assay may be carried out with the subject device, where the sample is introduced into port 26 and a first buffer reagent into port 28 and the two streams moved into the main channel to mix by means of first activating electrodes 30 and 20 and then activating electrodes 32 and 20. The sample and reagent are allowed to mix and the mixture moved into juxtaposition to conduit 42. The barrier 46 is removed by photodegradation. Then, a second reagent is introduced into the main channel from chamber 34 by means of electrodes 38 and 20 and the second reagent allowed to react with the mixture. After sufficient time for reaction, the assay mixture is moved to chamber 48. The composition used to form the gel wall 62 may be removed through side conduit 54 and port 56, using electrodes 58 and 20. A third reagent is transferred into the chamber 48 by means of the electrical field generated by electrodes 58 and 20 and the third reagent introduced into channel 50 through port 56 by means of the electrical field generated by electrodes 58 and 20. By having a third reagent that provides a detectable signal in proportion to the amount of a compound of interest in the sample, the detectable signal may now be read and the assay completed.

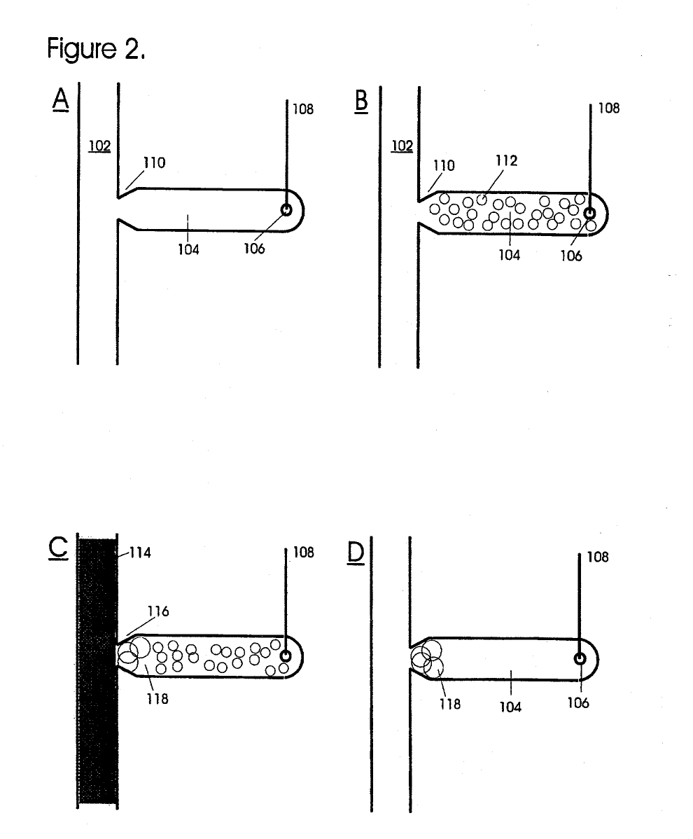

FIGS. 2A-D are diagrammatic views of the process for creating a wall. In FIG. 2A a portion of a device 100 is shown having a major channel 102 and a side channel 104. Side channel 104 has port 106 into which electrode 108 intrudes. Side channel 104 has a constricted opening 110 at the juncture to the major channel 102. In FIG. 2B a fluid composition 112 is introduced into side channel 104 through port 106 and moved to the constricted opening 110 by means of an electrical field between electrode 108 and a second electrode, not shown. The fluid composition has a liquid carrier and gel particles that expand upon a change in pH, ionic strength or the like, and will retain the expanded state for an extended period of time. In FIG. 2C, a fluid 114 is introduced into major channel 102, which is the required property for expanding the gel particles 116 to provide a substantially liquid impermeable barrier 118 at the constricted opening 110. In FIG. 2D, after formation of the barrier 118, the liquid 114 is removed from the major channel 102 and the fluid composition 112 is removed from the side channel 104 with a syringe through port 106, with air passing through the barrier 118 or through another channel, not shown. When a material is to be introduced into the major channel 102 through side channel 104, the gel may be melted with heat to permit liquid communication between side channel 104 and major channel 102.

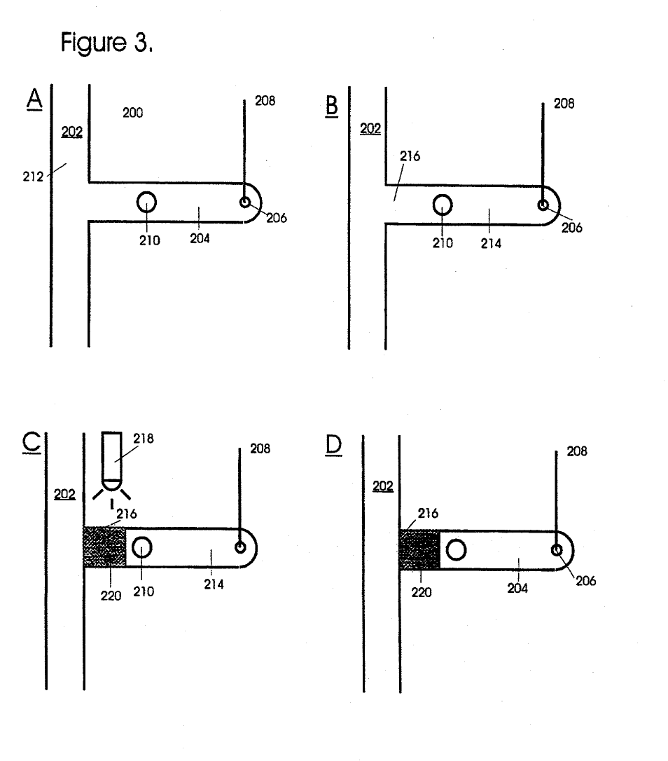

FIGS. 3A-D are diagrammatic views of an alternative process for creating a barrier between two channels. In FIG. 3A a portion of a device 200 is shown having a major channel 202 and a side channel 204. Side channel 204 has port 206 into which electrode 208 intrudes. Side channel 204 has a second port 210. Extending through major channel 202 and side channel 204 is an inert liquid 212. In FIG. 3B a monomeric fluid composition 214 is introduced into side channel 204 through port 206 and moved to the intersection 216 between the main channel 202 and the side channel 204 by control of the volume of the monomeric fluid composition 214 and mild pressure. The monomeric fluid composition 214 is comprised of a monomer and a photolytically active initiator. In FIG. 3C, the fluid 214 at the intersection 216 is irradiated by means of LED 218 to polymerize and form an impermeable barrier 220 at the intersection 216. In FIG. 3D, after formation of the barrier 220, the fluid composition 212 is removed from the major channel 202 and the monomeric fluid composition 214 is removed from the side channel 204 with a syringe through port 206. When a material is to be introduced into the major channel 202 through side channel 204, the polymeric barrier 220 may be melted with heat to permit liquid communication between side channel 204 and major channel 202 or may be retained and allow for transport of particles through the barrier under the influence of an electrical field.

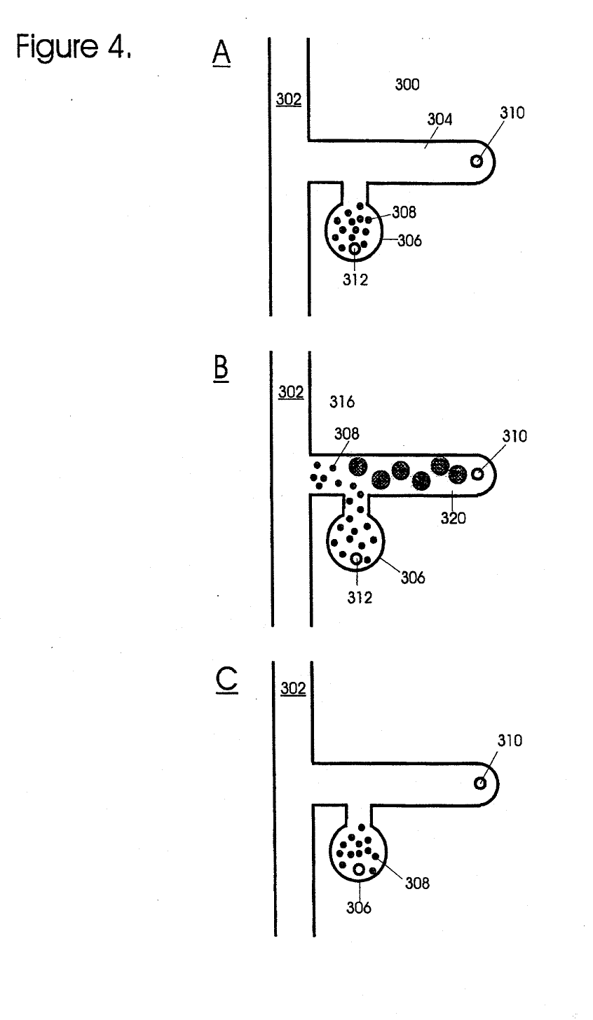

In FIGS. 4A-D, use of superparamagnetic beads is depicted as a fragment of a microfluidic device. In FIG. 4A, the device 300 has main channel 302, side channel 304 and magnetic bead reservoir 306 in which resides magnetic beads 308. Side channel 304 had port 310 and magnetic bead reservoir 306 has port 312 for charging and removal of beads. Alternatively, the magnetic beads could be enclosed during the fabrication of the device, particularly if the device is to be used only once or a few times and then thrown away. Buffer 314 extends throughout the device. The magnetic beads 308 are held in the magnetic bead reservoir and the main channel 302 and the side channel 304 are in fluid communication. In FIG. 4B, the magnetic beads 308 have been moved into channel 304 to form barrier 316. As illustrative, the buffer 314 has been removed from the side channel 304 by means of a syringe through port 310 and replaced with cells 318 and lysate buffer 320. After lysing the cells to form a lysate medium, as depicted in FIG. 4C, the magnetic beads are returned to the magnetic bead reservoir 306 to restore communication between the main channel 302 and the side channel 304. The components of the lysate medium may now be electrostatically moved to the main channel for further operations.

The following examples are offered by way of illustration and not by way of limitation.

### EXPERIMENTAL

### Example A

Production of microfluidic chips.

a) Glass chips were fabricated according to the protocol of Simpson et al., PNAS USA 95, 2256-61, 1998. Briefly, clean 4″ diameter, 1.1 mm thick borofloat glass substrates (Precision Glass and Optics, Santa Ana, Calif.) were coated with a ˜1500 Angstroms thick layer of amorphous silicon using plasma enhanced chemical vapor deposition. Substrates were coated with photoresist (Shipley 1818) by spinning at 6000 rpm for 30 sec and then baked at 90° C. for 25 min. Channel patterns were transferred to the substrates using photolithography and the exposed amorphous silicon was removed in a CF, plasma. Finally, channels were formed by wet chemical etching of the glass in a concentrated HF solution. The amorphous silicon acts as an etch mask to protect unexposed regions of the substrate from attack by HF. After etching, the photoresist was removed in a H₂SO₄:H₂O₂ solution (3:1) and the remaining amorphous silicon was etched by a CF plasma. The final channel cross-section was trapezoidal; 50 μm deep, 120 μm wide at the top of the channel and 50 μm wide at the bottom of the channel. Reservoir holes were drilled into the etched chip using a 1.2 mm diamond-tipped drill bit. A second 4″ substrate was thermally bonded to the etched substrate to seal the channels. Bonding was performed at 620° C. in a vacuum furnace.

b) Single-channel plastic chips were fabricated by injection molding as reported previously (McCormick, et al., Anal. Chem. 69, 2626-30, 1997), except that the chips were sealed with an acrylic cover plate by thermal bonding under pressure. Multichannel plastic chips were also fabricated by injection molding. However, the electroform used for the molding insert was prepared from an etched glass master. The multichannel chips were sealed by hot-roll lamination of a film (Top Flight MonoKote, Great Planes Model Distributors, Champaign, Ill.) at 110° C.±5° C. in a clean room. Excess film was trimmed from the edges using a razor knife.

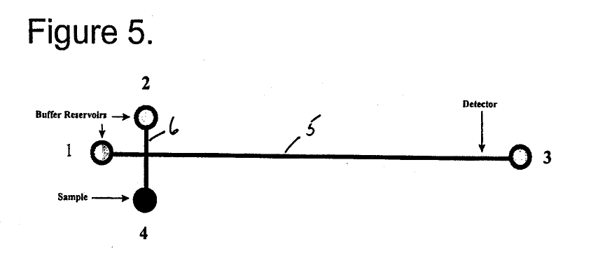

The channel design used in the following examples is shown in FIG. 5, with reservoirs 1 and 3 connected by channel 5 and reservoirs 2 and 4 connected by channel 6. For operation, reservoirs 1 and 2 are buffer reservoirs, 3 is a waste reservoir and 4 is a sample reservoir.

### Example 1

Polymerization with riboflavin/TEMED

A stock solution containing acrylamide and methylene bisacrylamide (BIS) was prepared at 20.8% T and 3.33% C in 100 μM phosphate buffer, pH 6.76. (%T is a measure of the total monomer concentration; in this case, the grams of acrylamide and BIS added to 100 mL of buffer. %C is a measure of the crosslinker concentration. In this case, the weight % of BIS relative to the combined mass of acrylamide and BIS). To 1 mL of this stock solution was added 0.333 mL of 100 mM phosphate buffer, pH 6.76. The solution was degassed under a 25 in Hg vacuum for ˜30 min. 0.9 mL of the degassed solution was withdrawn and transferred to a microcentrifuge tube wrapped in aluminum foil. To the monomer solution was added 0.5 μL of TEMED and 100 μL of 0.1 mM riboflavin. To fill the chip, 10 μL of the monomer/photoinitiator solution was added to reservoir 3 of a Monokote-sealed acrylic chip. After the channels had been filled by capillary action, 10 μL of the same solution was added to reservoir 1 followed by the addition of 10 μL of 2% hydroxycellulose (HEC) to each of reservoirs 2 and 4 and the solution in reservoir 3 was replaced by 2% HEC. The HEC solution serves to reduce undesired hydrodynamic flow in the channels during photopolymerization. The chip was covered with black duct tape, such that only arms leading to reservoirs 2 and 4 were visible. The chip was placed under a hand-held UV-365 source (UVP UVL-56 (6W, Hg vapor, 1350 μW/cm² at 3 in) and illuminated for 20 min. The tape was removed and reservoir 1 was washed with 10 μL of 1 X TBE. A suspension of ˜0.1% superparamagnetic particles (carboxylated JSR Co.) in 1 X TBE was added to reservoir 1 and 500 V applied to reservoir 3. Under the imposition of the voltage, the beads migrated out of reservoir 1 and accumulated against the interface of buffer and gel immediately adjacent to the channel intersection.

### Example 2

Polymerization with riboflavin/TEMED/DPIC/sucrose and electrophoresis of DNA

An acrylamide/BIS solution was prepared at 6%T and 3%C in 1 X TBE containing 60% sucrose by weight. The solution was degassed and 0.5 μL TEMED, 10 μL 0.1 mM riboflavin, and 25 μL 1 mM DPIC added to 0.99 mL of the monomer/sucrose solution. A MonoKote-sealed chip was filled with the solution and 2% HEC placed into each reservoir to block hydrodynamic flow. Channel 6 was masked with black tape, leaving channel 5 exposed. The chip was illuminated under the UV source overnight. The contents of the reservoirs were replaced with 1 X TBE and the chip was pre-electrophoresed until the current reached steady-state. A fluoresceinated DNA marker (Fluorescein Low Range DNA Standard, BioRad, Richmond, Calif.) was loaded in reservoir 4 and injected into the separation channel. The separation was monitored approximately 1 cm down-stream from the channel intersection. All fragments were resolved except for the 220 hp and 221 hp which co-migrated.

### Example 3

Polymerization of temperature-sensitive polymer in a chip.

A solution of 15%T, 3%C N-isopropyl acrylamide/BIS in 100 mM phosphate buffer was degassed for 30 min under a vacuum of 25 in Hg. To 0.9 mL of this solution was added 0.1 mL of 0.1 mM riboflavin and 0.5 μL TEMED. A MonoKote-sealed plastic chip was filled with the monomer/photoinitiator solution by capillary action and each reservoir was filled with 10 μL of the same solution. A solution of 2% HEC was added to reservoirs 2, 3, and 4 to minimize hydrodynamic flows during polymerization. The chip was placed on the objective stage of an inverted microscope and the channel intersection was illuminated from above by a Hg arc lamp through Koehler optics. The illuminated region was octagonal and the span was approximately 7 channel widths. The chip was allowed to stand for 30 min to ensure polymerization. The resulting gel was white, indicating that the exothermic polymerization had raised the temperature above the lower critical solution temperature of poly-N-isopropyl acrylamide.

### Example 4

Formation of gel barrier using agarose.

A solution of 2% low-melt agarose (BioRad, Richmond, Calif.) was prepared by heating in 1 X TBE in a microwave. A plastic chip sealed with a cover plate was heated briefly under a hair dryer. The chip was filled with 1 X TBE and the hot agarose solution was loaded into one reservoir. A vacuum was applied to a second reservoir to pull the agarose through the channel. After allowing the chip to cool, superparamagnetic beads were electrophoresed against the agarose in the structure. The agarose gel blocked the migration of the beads.

It is evident from the above results, that the subject methods allow for the prevention of intermixing of different media, reagents, etc. allowing for retention of materials at one site while performing other operations and then being able to release a material at the appropriate time. In this way chips can be preloaded with reagents without there being mixing or subsequent interference with the process being performed in the device, until the time for the material to be introduced.

Although the foregoing invention has been described in some detail by way of illustration and example for purposes of clarity of understanding, it will be obvious that certain changes and modifications may be practiced within the scope of the appended claims. All references cited herein are incorporated herein by reference, as if set forth in their entirety.

What is claimed is:

1. A method to create a barrier to flow in a microfluidic device, comprising the steps of:
introducing a photopolymerizable material in an intersection formed between a first and second microchannel in the device, and
forming a localized gel by photopolymerization at the intersection, wherein the gel acts to create a barrier to flow in the intersection.

2. The method of claim 1, applied to a plurality of said intersecting microchannels forming a microfluidic network contained in a single device.

3. The method of claim 2, wherein the microfluidic network is formed from enclosed channels patterned into a substrate.

4. The method of claim 3, wherein the substrate is plastic.

5. The method of claim 1, wherein the first microchannel has two openings bounding a length of the first microchannel, wherein the localized gel is precluded from formation within the length.

6. The method of claim 1, wherein the forming step includes using a mask to shield portions of the first and second microchannels from light, thereby to localize formation of the gel.

7. The method of claim 1 wherein the photopolymerizable mixture comprises a monomer and a photoactivated initiator.

8. The method of claim 1 wherein the forming step is effected by a light emitting diode.

9. The method of claim 1 wherein the forming step is effected by ultraviolet light.

10. The method of claim 1, further comprising the step of removing nonpolymerized liquid from at least one of the intersecting microchannels.

11. The method of claim 10, wherein the removing step is effected by including a first and second opening into the at least one microchannel, wherein fluid is evacuated through the first opening, and replacement fluid is introduced through the second opening.

12. The method of claim 1, further comprising the step of removing the localized gel.

13. A microfluidic device comprising:
a first microchannel;
a second microchannel intersecting the first microchannel; and
a localized, photopolymerized gel filling the volume formed by intersection of the first and second microchannels.

14. The device of claim 13, wherein the first and second microchannels are disposed at right angles relative to each other.

15. The device of claim 13, further comprising a pair of ports in the first microchannel, both disposed on one side of the gel contained in the intersection.

16. A method of effecting reactions in a microfluidic network, wherein the network comprises first and second microchannels intersecting at an angle, the method comprising:
filling the first and second microchannels with a photopolymerizable mixture;
illuminating an area of the intersection to cause localized gel photopolymerization at the intersection;
removing the unpolymerized mixture from the first and second microchannels;
introducing a reaction mixture into the first microchannel;
effecting a reaction in the first microchannel;
moving products of the reaction by electrophoresis through the gel contained in the intersection and into the second microchannel.

17. The method of claim 16 wherein the reaction is the polymerase chain reaction.

18. The method of claim 16 wherein the reaction is a nucleic acid sequencing reaction.

19. The method of claim 16 wherein the reaction is isothermal.

20. The method of claim 16 wherein the reaction is a compound screening reaction.

21. The method of claim 16 wherein the photopolymerization mixture comprises a monomer and a photoactivated initiator.

22. The method of claim 16 wherein the illuminating step is effected by a light emitting diode.

23. The method of claim 16 wherein the illuminating step is effected by ultraviolet light.

24. The method of claim 16, further comprising the step of removing the localized gel.
